(19) United States
(12) Patent Application Publication
(10) Pub. No.: US 2025/0171235 A1
(43) Pub. Date: May 29, 2025

(54) INTELLIGENT SYSTEM FOR WAREHOUSE FULFILLMENT OPERATORS

(71) Applicants: Zhen-Sheng Wang, SANTA FE SPRINGS, CA (US); Ze-Nong Wang, SANTA FE SPRINGS, CA (US); Ze-Feng Wang, SANTA FE SPRINGS, CA (US)

(72) Inventors: Zhen-Sheng Wang, SANTA FE SPRINGS, CA (US); Ze-Nong Wang, SANTA FE SPRINGS, CA (US); Ze-Feng Wang, SANTA FE SPRINGS, CA (US)

(21) Appl. No.: 18/522,272

(22) Filed: Nov. 29, 2023

(51) Int. Cl. B65G 1/137

(52) U.S. Cl. CPC B65G 1/1373; B65G 1/1371

(57) ABSTRACT

The present invention provides an intelligent system for warehouse fulfillment operators, including a supplier intelligent management module for providing supplier numbers, a warehouse intelligent management module for providing operator information and operator level information, and an operator intelligent management module for retrieving the operator information and the operator level information and generating the most suitable operator through artificial intelligence computation to prevent warehouse personnel from choosing suboptimal operators and to enhance warehouse management efficiency.

### BACKGROUND OF THE INVENTION

### Fields of the Invention

The present invention relates to a technical field of warehouse management and, more particularly to, an intelligent system for warehouse fulfillment operators.

### Descriptions of Related Art

With the increasing market competition and rapid development of international trade, many businesses are beginning to focus on the efficiency of warehouse management. Most existing warehouse management systems still rely on paper documents to record information related to goods in and out. Moreover, when shipping goods, the selection of operators typically is based on experiences of warehouse personnel. This approach cannot properly select the most suitable operator and cannot achieve standardized warehouse management, resulting in a high error rate and affecting the efficiency of goods shipping. Therefore, developing an intelligent system for warehouse fulfillment operators that can improve work efficiency and reduce operating costs is one of the primary research topics of the present invention.

### SUMMARY OF THE INVENTION

The primary objective of an intelligent system for warehouse fulfillment operators according to the present invention is to provide an automated recommendation of the most suitable operator through artificial intelligence computation, preventing warehouse personnel from choosing suboptimal operators and enhancing warehouse management efficiency.

To achieve the above objectives, the intelligent system for warehouse fulfillment operators of the present invention includes a supplier intelligent management module for providing supplier numbers, a warehouse intelligent management module for providing operator information and operator level information, and an operator intelligent management module for retrieving the operator information and the operator level information and generating the most suitable operator through artificial intelligence computation to prevent warehouse personnel from choosing suboptimal operators and to enhance warehouse management efficiency.

In the present, the goods content has goods name, goods type, goods inbound date, goods outbound date, and goods volume.

In the present invention, the storage bin content has inbound date, outbound date, storage bin location, storage bin quantity, and storage bin attribute.

In the present invention, the operator content has operator name, shipping address, goods type, shipping number, and shipping storage bin.

In the present invention, the shipping number corresponds to content of the goods number, and the shipping storage bin corresponds to content of the storage bin number.

In the present invention, the system further includes a terminal module. The terminal module can be a multimedia mobile device, and the multimedia mobile device may be a personal digital assistant (PDA), phone, or tablet.

In the present invention, the system further includes a switch module for switching from an automatic allocation mode to a manual selection mode.

### BRIEF DESCRIPTION OF THE DRAWINGS

FIG. 1 is a system block diagram of the present invention.

FIG. 2 is a system block diagram of a warehouse intelligent management module of the present invention.

FIG. 3 is a system block diagram of an operator intelligent management module of the present invention.

FIG. 4 is a system block diagram of goods content of the present invention.

FIG. 5 is a system block diagram of storage bin content of the present invention.

FIG. 6 is a system block diagram of operator content of the present invention.

### DETAILED DESCRIPTION OF THE PREFERRED EMBODIMENT

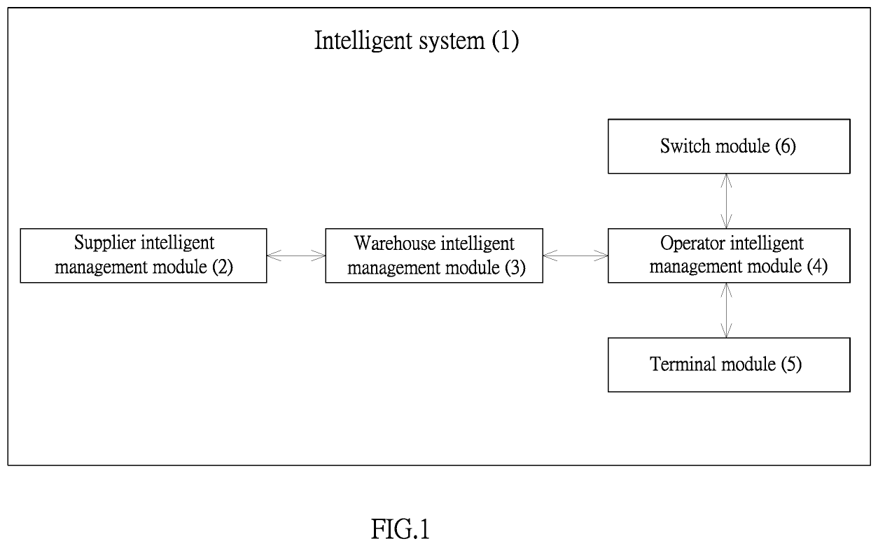

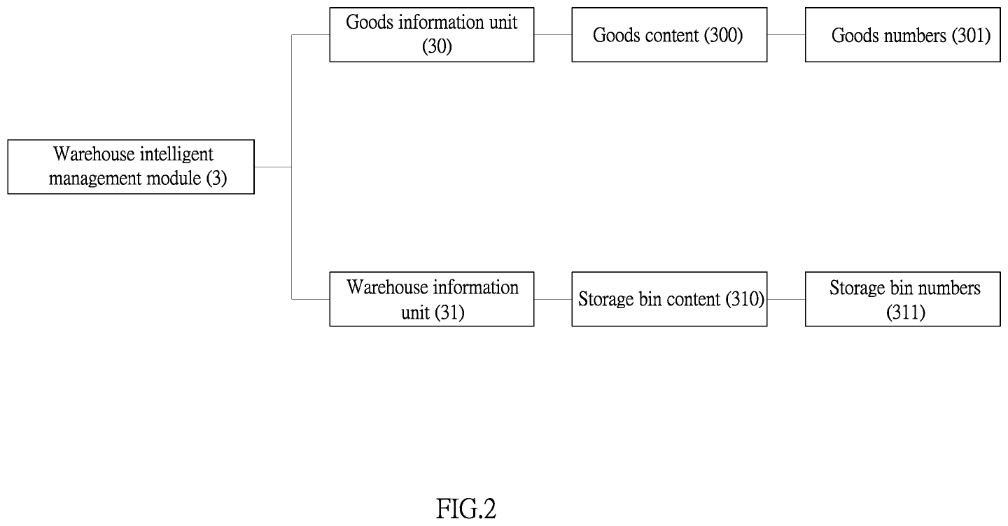

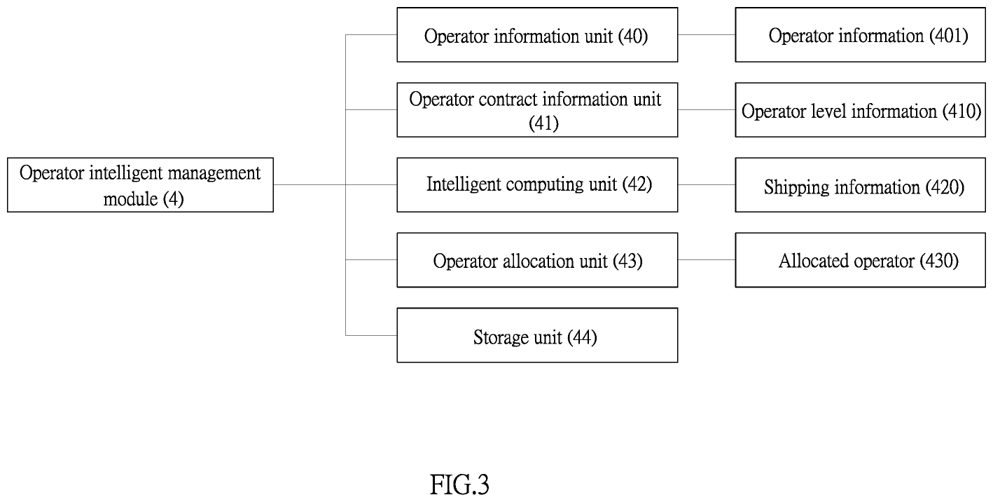

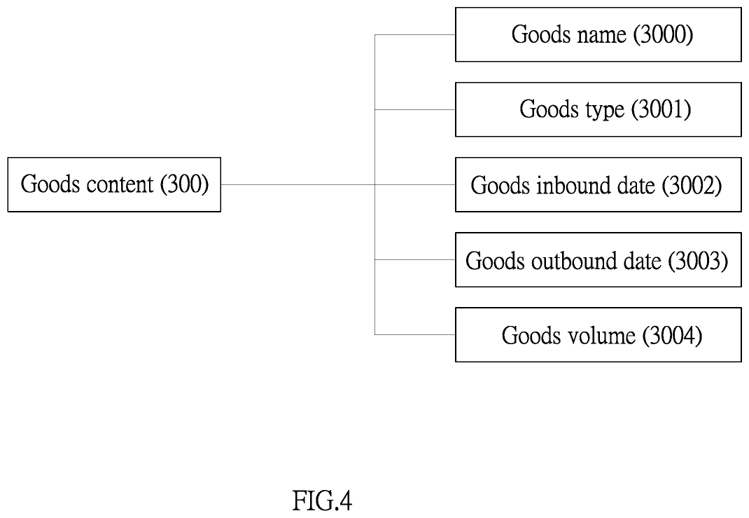

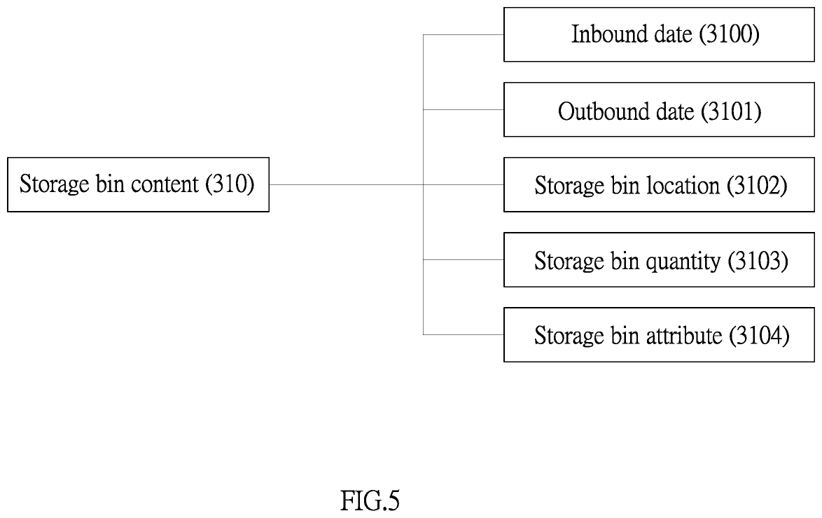

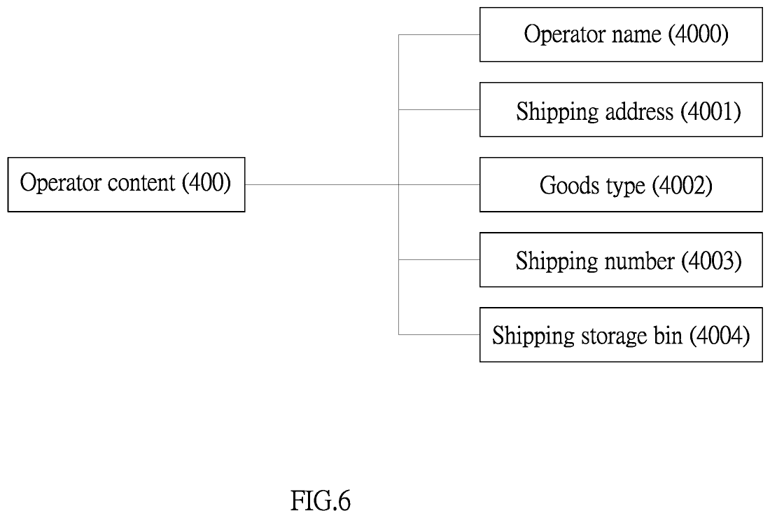

As shown in FIGS. 1 to 6, the present invention provides an intelligent system 1 for warehouse fulfillment operators, comprising a supplier intelligent management module 2, a warehouse intelligent management module 3, and an operator intelligent management module 4 in mutual connection.

The supplier intelligent management module 2 has a supplier information unit, which arranges supplier numbers in a preset order based on the quantity of suppliers and the historical records of supplier inventory.

The warehouse intelligent management module 3 has a goods information unit 30 and a warehouse information unit 31 in mutual connection. The goods information unit 30 has goods content 300, including goods name 3000, goods type 3001, goods inbound date 3002, goods outbound date 3003, and goods volume 3004. The goods information unit 30 generates goods numbers 301 based on the goods content 300.

The warehouse information unit 31 has storage bin content 310, including inbound date 3100, outbound date 3101, storage bin location 3102, storage bin quantity 3103, and storage bin attribute 3104. The warehouse information unit 31 generates storage bin numbers 311 based on the storage bin content 310.

The operator intelligent management module 4 has an operator information unit 40, an operator contract information unit 41, an intelligent computing unit 42, an operator allocation unit 43, and a storage unit 44 in mutual connection.

The operator information unit 40 has operator content 400, including operator name 4000, shipping address 4001, goods type 4002, shipping number 4003, and shipping storage bin 4004. The operator information unit 40 generates operator information 401 based on the operator content 400. In this embodiment, the shipping number 4003 corresponds to the content of the goods number 301, and the shipping storage bin 4004 corresponds to the content of the storage bin number 311.

The operator contract information unit 41 generates operator level information 410 based on contract price. The operator level information 410 categorizes operators, with the one offering the most favorable price ranked as the highest priority level, the next favorable-priced operator as the second-highest priority level, and so on. In case of the same price, priority is given to the one with the earliest contract time.

The intelligent computing unit 42 retrieves the operator information 401 and the operator level information 410 and generates shipping information 420 through artificial intelligence computation. The operator allocation unit 43 automatically allocates the most suitable operator 430 based on the shipping information 420, and the storage unit 44 stores the content of the shipping information 420.

Additionally, the system of the present invention further includes a terminal module 5 with a display unit. The display unit displays the allocated operator 430 by the operator allocation unit 43. In this embodiment, the terminal module 5 can be a multimedia mobile device, such as a personal digital assistant (PDA), phone, or tablet.

In use, warehouse personnel can use the display unit 50 of the terminal module 5 to know which operator 430 is responsible for transporting the goods. The warehouse personnel can decide whether to accept the operator 430 by the system's intelligent recommendation. If agreed, the display unit 50 of the terminal module 5 (PDA) further displays the shipping information 420 and the operator information 401 for the warehouse personnel to understand the shipping situation of the operator 430. Additionally, the system also includes a switch module 6. If the warehouse personnel do not accept the system-recommended operator 430, the system can be switched from an automatic allocation mode to a manual selection mode through the switch module 6. This allows the warehouse personnel to reselect the operator 430 based on the actual situation. The reason for maintaining this flexibility of the system is that when the system cannot operate intelligently in the event of an emergency in the warehouse, the system can be switched to the manual selection mode to avoid delaying shipping operations.

In summary, the intelligent system 1 for warehouse fulfillment operators according to the present invention utilizes the intelligent computing unit 42 of the operator intelligent management module 4 to generate the shipping information 420 by using artificial intelligence computation on the operator information 401 and the operator level information 410. Then, the operator allocation unit 43 automatically recommends the most suitable operator 430 based on the shipping information 420, preventing the warehouse personnel from choosing a suboptimal operator 430. Accordingly, the present invention provides an intelligent system 1 for warehouse fulfillment operators constructed by a supplier end, a warehouse end, and an operator end, to effectively enhance warehouse management efficiency.

What is claimed is:

1. An intelligent system for warehouse fulfillment operators, comprising a supplier intelligent management module, a warehouse intelligent management module, and an operator intelligent management module in mutual connection, wherein
the supplier intelligent management module is configured to provide supplier numbers;
the warehouse intelligent management module has a goods information unit and a warehouse information unit in mutual connection, wherein the goods information unit has goods content and is configured to generate goods numbers based on the goods content, and the warehouse information unit has storage bin content and is configured to generate storage bin numbers based on the storage bin content;
the operator intelligent management module has an operator information unit, an operator contract information unit, an intelligent computing unit, an operator allocation unit, and a storage unit in mutual connection;
the operator information unit has operator content and is configured to generate operator information based on the operator content;
the operator contract information unit is configured to generate operator level information based on contract price;
the intelligent computing unit is configured to retrieve the operator information and the operator level information and generate shipping information through artificial intelligence computation;
the operator allocation unit is configured to automatically allocate the most suitable operator based on the shipping information; and
the storage unit is configured to store content of the shipping information.

2. The intelligent system for warehouse fulfillment operators as claimed in claim 1, wherein the goods content has goods name, goods type, goods inbound date, goods outbound date, and goods volume.

3. The intelligent system for warehouse fulfillment operators as claimed in claim 1, wherein the storage bin content has inbound date, outbound date, storage bin location, storage bin quantity, and storage bin attribute.

4. The intelligent system for warehouse fulfillment operators as claimed in claim 1, wherein the operator content has operator name, shipping address, goods type, shipping number, and shipping storage bin.

5. The intelligent system for warehouse fulfillment operators as claimed in claim 4, wherein the shipping number corresponds to content of the goods number, and the shipping storage bin corresponds to content of the storage bin number.

6. The intelligent system for warehouse fulfillment operators as claimed in claim 1, further comprising a terminal module.

7. The intelligent system for warehouse fulfillment operators as claimed in claim 6, wherein the terminal module is a multimedia mobile device, and the multimedia mobile device is a personal digital assistant (PDA), phone, or tablet.

8. The intelligent system for warehouse fulfillment operators as claimed in claim 1, further comprising a switch module for switching from an automatic allocation mode to a manual selection mode.
